(19) United States
(12) Patent Application Publication
(10) Pub. No.: US 2007/0023730 A1
(43) Pub. Date: Feb. 1, 2007

(54) Hydrofluorocarbon refrigerant compositions

(75) Inventors: Martin Paonessa, Niagara Falls, NY (US); Rajiv Singh, Getzville, NY (US); David Wilson, East Amherst, NY (US); Mark Spatz, East Amherst, NY (US); Samuel Yana Motta, East Amherst, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/190,574

(22) Filed: Jul. 27, 2005

(51) Int. Cl. C09K 5/04

(52) U.S. Cl. 252/68

(57) ABSTRACT

A composition comprising from about 80 weight percent to about 99.9 weight percent of at least one C₁-C₅ hydrofluorocarbon and from about 0.1 weight percent to about 20 weight percent of at least one C₃-C₇ alcohol, and the use of these composition for in methods of the recharging of refrigeration systems.

### BACKGROUND

1. Field of Invention

The invention relates generally to hydrofluorocarbon compositions and to methods for charging and recharging heat transfer systems based on working fluids, including methods of replacing the working fluid.

2. Description of Related Art

Chlorofluorocarbons (CFCs) and hydrochlorofluorocarbons (HCFCs), such as dichlorofluoromethane (R-12), monochlorodifluoromethane (R-22), and azeotropic mixtures of monochlorodifluoromethane and chloropentafluoroethane (R-115) (known as R-502), have conventionally been used as heat transfer fluids in heating and cooling systems, particularly as refrigerants in cooling systems. However, in general these compounds are known to deplete the Earth's ozone layer and thus are considered to be “environmentally unfriendly”.

There has thus been a need to develop new materials as alternatives to CFCs and HCFCs. Hydrofluorocarbons (HFCs) and hydrofluorocarbon blends are of particular interest as such alternatives because in many cases they possess properties that are similar to chlorofluorocarbons, including similar heat transfer/refrigeration characteristics (e.g., a vapor pressure that is plus or minus 20 percent at the same temperature of the heat transfer fluid it is replacing), chemical stability, low toxicity, non-flammability, efficiency in-use and low temperature glides. Unlike CFCs and HCFCs, HFCs do not damage the ozone layer, and thus are considered environmentally friendly. Moreover, HFCs generally possess a good efficiency in-use which is important, for example, in air conditioning and refrigeration where a loss in refrigerant thermodynamic performance or energy efficiency may have secondary environmental impacts through increased fossil fuel usage arising from an increased demand for electrical energy.

Some HFCs are known to be exceptional refrigerants, including, but not limited to, difluoromethane (R-32), 1,1,1,2,2-Pentafluoroethane (R-125), 1,1,1-trifluoroethane (R-143a), 1,1,1,2-tetrafluoroethane (R-34a), and 1,1-difluoroethane (R-152a). Certain blends of two or more of these HFCs can also be used to achieve particular thermodynamic properties. Common HFC blends include an azeotrope-like blend of R-143a and R-125 (known as R-507A), a non-azeotropic blend of R-125, R-143a, and R-134a (known as R-404A), a non-azeotropic blend of R-32 and R-125 (known as R-410A), and a non-azeotropic blend of R-32, R-125, and R-134a (known as R407C). These alternative refrigerants are available commercially from various sources including Honeywell, DuPont, Atochem and ICI.

Each of these HFCs or HFC blends can serve as a replacement for one or more CFCs or HCFCs. For example, R-134a can serve as replacement of R-12 in refrigeration and air conditioning applications such as chillers; R-404A and R-507A can serve as replacements for R-502 in most refrigeration applications, including high, medium and low evaporation temperature systems; R410A can serve as replacement of R-22 in new air conditioning and refrigeration equipment: and R-407C can serve as a replacement for R-22 in various air-conditioning applications, as well as in most refrigeration systems including chillers. Since R-407C is a close match to R-22, it also serves as a retrofit fluid in applications where R-22 is generally used.

However, widespread commercial use of these and other HFC refrigerants has been hindered in many cases by the relative performance of the HFC in combination with the lubricants frequently used in heat transfer systems, particularly refrigeration systems. Refrigeration system designers are interested in how the lubricant behaves in the system so that they can design piping, compressors, valves and other components to best manage lubricant effectiveness, particularly return of the lubricant to the compressor in such systems. The behavior of a refrigerant in combination with the lubricant used in the system can affect the performance properties of the heat transfer systems, such as for example the film characteristics on heat transfer surfaces, and thus energy efficiency performance. One important property is the compatibility, particularly the miscibility, between the lubricant and the heat transfer fluid, such as the liquid refrigerant.

Thus applicants have come to appreciate that the HFC-based refrigerants that have heretofore been used to replace HCFC and CFC refrigerants interact with conventional refrigeration systems lubricant(s) in a different manner than the refrigerant being replaced, which in turn adversely effects both compressor durability and system performance. For example, mineral oil and alkyl benzenes, which have heretofore frequently been used with conventional refrigerants such as R-12, R-502 and R-22, are generally immiscible or otherwise not sufficiently compatible with HFCs and must therefore be replaced with other more miscible or compatible lubricants, such as polyol ester (POE) or other synthetic lubricants. Applicants have come to recognize the substantial disadvantages associates with these features of the prior systems. For example, the cost, both in terms of materials and time associated with lubrication removal and replacement can be substantial. Moreover, major development considerations for the synthetic lubricants and other, more compatible lubricants remain, including miscibility, solubility, stability, electrical properties, lubricity and other retrofitting requirements.

Since HFCs are generally immiscible in many conventional lubricants, retrofitting refrigeration or air conditioning systems, particularly those designed to operate with non-HFC refrigerants such as CFCs and HCFCs, with HFC heat transfer fluids, particularly refrigerants, typically requires the removal of as much of the lubricant oil as possible before introducing the new refrigerant(s) with synthetic lubricants. This process often involves at least partial disassembly of the system, such as temporarily removing the compressor from the system so that the lubricant can be adequately removed, for example by drainage. For these and other reasons, applicants have come to appreciate that it would be highly desirable to retrofit or recharge a non-HFC system, such as a CFC or HCFC system, with HFC without having to remove the existing lubricant from the system.

### SUMMARY OF THE INVENTION

By discovering a system which substantially reduces or eliminates the need to remove substantially all of the existing lubricant as part of recharging or retrofitting an existing heat transfer system which is using a non-HFC heat transfer fluid, applicants have envisioned and developed the ability to perform such a retrofit as a relatively simple “drop-in” operation. That is, applicants concept involves in certain preferred embodiments that the existing heat transfer fluid in such a system would be replaced with a new heat transfer fluid in accordance with the present invention, preferably without any substantial further change in the system, such as without any substantial disassembly of the system components.

One aspect of the present invention, therefore, involves applicants' discovery that the miscibility of HFCs in conventional lubricants, such as non-synthetic lubricants, can be greatly increased by combining the HFC with one or more C₃-C₇ alcohols, preferably C₃-C₇ secondary alcohols. By utilizing compositions comprising a combination of HFC and such alcohol(s) as the new heat transfer fluid, heat transfer systems which were designed to use and/or are using non-HFC heat transfer fluids, such as CFC- or HCFC-based systems, can be retrofitted to operate with HFC heat transfer fluid without having to remove and/or replace the system's existing lubricant(s). In addition, it has been found that certain combinations of HFCs and C₃-C₇ alcohols also possess certain thermodynamic property(s) that are not substantially inferior, and preferably approximately about the same as the heat transfer fluid that is being replaced.

Accordingly, the present invention provides, in one aspect, compositions comprising at least one C₁-C₅ hydrofluorocarbon, preferably in an amount of from about 80 weight percent to about 99.9 weight percent of the composition, and at least one C₃-C₇ alcohol, preferably in an amount of from about 0.1 weight percent to about 20 weight percent of the composition. As used herein, the term C₁ —C₅ hydrofluorocarbon refers to compounds which contain one to about 5 carbon atoms, at least one atom of hydrogen, and at least on atom of fluorine but no other halogens. As used herein, the term C₃-C₇ alcohol refers to compounds which contain from 3 to 7 carbon atoms wherein at least one carbon atom is part of a C—OH moiety, but otherwise this term is not intended to be restricted.

Another aspect of the invention provides methods of recharging or retrofitting a an existing heat transfer system which contains or has contained a non-HFC heat transfer fluid and an existing lubricant compatible with said non-HFC heat transfer fluid comprising the steps of (a) providing said heat transfer system in a condition such that said non-HFC heat transfer fluid, preferably a chlorine-containing heat transfer fluid (more preferably a chlorine-containing refrigerant) is not substantially present, and in which a substantial portion of said lubricant is present; and (b) introducing a composition according to the present invention into the system and thereby into contact with said lubricant. In certain embodiments, the providing step (a) also comprises substantially removing said non-HFC heat transfer fluid from said system.

A preferred embodiment of the present invention provides methods of recharging a refrigeration system comprising the steps of (a) providing a refrigeration system having at least one chlorine-containing refrigerant and at least one lubricant; (b) substantially removing said chlorine-containing refrigerant while retaining a substantial portion of said lubricant; and (c) introducing a composition according to the present invention into the system. Preferably, such embodiments do not include any substantial disassembly of the system. Also preferably, such embodiments do not include the step of adding a substantial amount of a synthetic lubricant to the system.

### BRIEF DESCRIPTION OF THE DRAWINGS

FIG. 1 is a plot of oil level in a refrigeration compressor sump (risers bypassed) versus time wherein the refrigeration system has been charged with a R-407C/2-pentanol blend according to the present invention.

FIG. 2 is a plot of oil level in a refrigeration compressor sump (risers open) versus time wherein the refrigeration system has been charged with a R-407C/2-pentanol blend according to the present invention.

### DETAILED DESCRIPTION OF THE INVENTION

One aspect of the present invention involves compositions comprising at least one HFC heat transfer fluid and a solubilizing agent, preferably comprising at least one C₃-C₇ alcohol, and the use of such compositions in applications such as the recharging of refrigeration systems. It is contemplated that the compositions of the present invention may also be utilized as aerosol propellants, heat transfer media, gaseous dielectrics, fire-extinguishing agents, foam blowing agents, solvents, as well as in numerous other applications.

As used herein, the term “solubilizing agent” broadly refers to a substance that increases the solubility and/or miscibility of the hydrofluorocarbons(s) and one or more lubricants in one another.

In certain preferred embodiments of the present invention, compositions are provided that comprise at least one HFC and an effective amount of a solubilizing agent. As used herein, the term “effective amount” with respect to solubilizing agents refers to an amount of the agent effective to dissolve or otherwise cause entrainment of (such as by dispersion, emulsification or the like) a sufficient amount of refrigerant in a lubricant such that the diluted lubricant can be transported through the system back to the compressor. In certain embodiments of the present invention, compositions are provided comprising from about 0.1 to about 20 weight percent of a solubilizing agent and from about 80 weight percent to about 99.9 weight percent of at least one HFC. More preferably, the compositions comprise from about 0.1 to about 15 weight percent of a solubilizing agent and from about 85 weight percent to about 99.9 weight percent of at least one HFC.

Preferred solubilizing agents include C₃-C₇ alcohols, more preferably C₃-C₇ secondary alcohols. As used herein, the term “secondary alcohol” refers to alcohols having two carbon substituents bonded to the hydroxyl-bearing carbon. Applicants have experimentally and unexpectedly determined that HFCs blended with secondary alcohols are generally more miscible in common lubricant oils than blends of HFCs and primary alcohols. Specifically, when a mixture of oil and a blend of HFCs and secondary alcohols is allowed to settle, the meniscus that forms between the top oil layer and the bottom HFC layer is much lower than the meniscus that occurs in mixtures of oil and blends of HFCs and primary alcohols.

Examples of secondary alcohols that may be utilized as part of the present invention include, but are not limited to, 2-proponal, 2-butanol, 2-pentanol, 3-pentanol, 2-hexanol, 3-hexanol, 2-heptanol, 3-heptanol, 4-heptanol, 2-methyl-3-pentanol, 3-butylen-2-ol, and the like. Preferred alcohols include 2-proponal, 2-butanol, 2-pentanol, 2-hexanol, 2-heptanol, with 2-pentanol being even more preferred.

In general, compositions of the present invention can include any HFC for which a C₃-C₇ alcohol may be added as a solubilizing agent. Preferred HFCs for use with the present invention include, but are not limited to, C₁-C₅ hydrofluorocarbons and blends thereof. More preferred HFCs include C₁-C₃ hydrofluorocarbons and blends thereof, with R-32, R-125, R-134a, R-143a, R-152a, R-507A, R-404A, R-410A, and R-407C being particularly preferred.

The compositions of the present invention are particularly miscible in lubricating oils such as mineral or hydrocarbon oil, alkyl benzene oil, white or paraffinic oil, and mixtures thereof. These lubricants are commercially available from various sources (e.g., Capella brand names from Texaco and Suniso brand names from Sun Oil). The chemical compositions and uses of these oils are well known (see e.g. “Fluorocarbon Refrigerants Handbook” by Ralph C. Downing, Prentice Hall, 1998, pp. 206-270).

For systems utilizing an HFC and a lubricant, the lubricant and/or HFC may be added to the system as a mixture, provided that the HFC and lubricant are at least miscible, and preferably also at least partially soluble, with each other. Therefore, according to certain embodiments of the present invention, compositions are provided comprising an HFC/C₃-C₇ alcohol blend and at least one lubricant, wherein said lubricant is present in an amount of from about 0.1 to about 99.9 weight percent, and preferably from about 0.2 to about 90 weight percent, based on the total weight of the composition.

The compositions of the present invention may also contain additives such as oxidation resistance and thermal stability enhancers, corrosion inhibitors, metal deactivators, lubricity additives, viscosity index enhancers, pour and/or floc point depressants, detergents, dispersants, antifoaming agents, anti-wear agents, and extreme pressure resistant additives. Many additives are multifunctional. For example, certain additives may impart both anti-wear and extreme pressure resistance properties, or function both as a metal deactivator and a corrosion inhibitor. Cumulatively, all additives preferably do not exceed 8 percent by weight, and more preferably do not exceed 5 percent by weight, of the total composition.

An effective amount of the foregoing additive types generally ranges from about 0.01 to about 5 weight percent for the antioxidant component, from about 0.01 to about 5 weight percent for the corrosion inhibitor component, from about 0.001 to about 0.5 weight percent for the metal deactivator component, from about 0.5 to about 5 weight percent for the lubricity additives, from about 0.01 to about 2 weight percent for each of the viscosity index enhancers and pour and/or floc point depressants, from about 0.1 to about 5 weight percent for each of the detergents and dispersants, from about 0.001 to about 0.1 weight percent for anti-foam agents, and from 0.1 to about 2 weight percent for each of the anti-wear and extreme pressure resistance components. All these percentages are by weight and are based on the total composition. It is to be understood that more or less than the stated amounts of additives may suitable under particular circumstances, and that a single type of compound or mixtures of types of compounds may be used for each type of additive component.

Examples of suitable oxidation resistance and thermal stability enhancers include, but are not limited to, diphenyl-, dinaphthyl-, and phenylnaphthyl-amines, in which the phenyl and naphthyl groups can be substituted, e.g., N,N′-diphenyl phenylenediamine, p-octyldiphenylamine, p,p-dioctyldiphenylamine, N-phenyl-1-naphthyl amine, N-phenyl-2-naphthyl amine, N-(p-dodecyl)phenyl-2-naphthyl amine, di-1-naphthylamine, and di-2-naphthyl amine; phenothazines such as N-alkylphenothiazines; imino(bisbenzyl); and hindered phenols such as 6-(t-butyl) phenol, 2,6-di-(t-butyl) phenol, 4-methyl-2,6-di-(t-butyl) phenol, 4,4′-methylenebis(2,6-di-{t-butyl} phenol), and the like.

Examples of suitable cuprous metal deactivators include, but are not limited to, imidazole, benzamidazole, 2-mercaptobenzthiazole, 2,5-dimercaptothiadiazole, salicylidine-propylenediamine, pyrazole, benzotriazole, tolutriazole, 2-methylbenzamidazole, 3,5-imethyl pyrazole, and methylene bis-benzotriazole. Benzotriazole derivatives are preferred. Other examples of more general metal deactivators and/or corrosion inhibitors include organic acids and their esters, metal salts, and anhydrides, e.g., N-oleyl-sarcosine, sorbitan mono-oleate, lead naphthenate, dodecenyl-succinic acid and its partial esters and amides, and 4-nonylphenoxy acetic acid; primary, secondary, and tertiary aliphatic and cycloaliphatic amines and amine salts of organic and inorganic acids, e.g., oil-soluble alkylammonium carboxylates; heterocyclic nitrogen containing compounds, e.g., thiadiazoles, substituted imidazolines, and oxazolines; quinolines, quinones, and anthraquinones; propyl gallate; barium dinonyl naphthalene sulfonate; ester and amide derivatives of alkenyl succinic anhydrides or acids, dithiocarbamates, dithiophosphates; amine salts of alkyl acid phosphates and their derivatives.

Examples of suitable lubricity additives include, but are not limited to, long chain derivatives of fatty acids and natural oils, such as esters, amines, amides, imidazolines, and borates.

Examples of suitable viscosity index enhancers include, but are not limited to, polymethacrylates, copolymers of vinyl pyrrolidone and methacrylates, polybutenes, and styrene-acrylate copolymers.

Examples of suitable pour point and/or floc point depressants include, but are not limited to, polymethacrylates such as methacrylate-ethylene-vinyl acetate terpolymers; alkylated naphthalene derivatives; and products of Friedel-Crafts catalyzed condensation of urea with naphthalene or phenols.

Examples of suitable detergents and/or dispersants include, but are not limited to, polybutenylsuccinic acid amides; polybutenyl phosphonic acid derivatives; long chain alkyl substituted aromatic sulfonic acids and their salts; and metal salts of alkyl sulfides, of alkyl phenols, and of condensation products of alkyl phenols and aldehydes.

Examples of suitable anti-foam agents include, but are not limited to, silicone polymers and certain acrylates.

Examples of suitable anti-wear and extreme pressure resistance agents include, but are not limited to, sulfurized fatty acids and fatty acid esters, such as sulfurized octyl tallate; sulfurized terpenes; sulfurized olefins; organopolysulfides; organo phosphorus derivatives including amine phosphates, alkyl acid phosphates, dialkyl phosphates, aminedithiophosphates, trialkyl and triaryl phosphorothionates, trialkyl and triaryl phosphines, and dialkylphosphites, e.g., amine salts of phosphoric acid monohexyl ester, amine salts of dinonylnaphthalene sulfonate, triphenyl phosphate, trinaphthyl phosphate, diphenyl cresyl and dicresyl phenyl phosphates, naphthyl diphenyl phosphate, triphenylphosphorothionate; dithiocarbamates, such as an antimony dialkyl dithiocarbamate; chlorinated and/or fluorinated hydrocarbons, and xanthates.

### EXAMPLES

The following examples are illustrative of the invention, though the invention is not limited to or by these examples.

Examples 1-3 demonstrate the miscibility of HFCs in secondary alcohols.

### Example 1

Blends of R407C and 2-pentanol were prepared as indicated in Table 1. 5 grams of one of these blends was mixed with 5 grams of white mineral oil and then placed in a glass tube. The mixture was allowed to settle and the meniscus which subsequently formed was measured from the bottom of the tube. This process was repeated for the remaining blends.

### Example 2

The process of Example 1 was repeated, except that the blends comprise R-407C and 1-pentanol.

### Example 3

The process of Example 1 was repeated, except that the blends comprise R-407C and 1-butanol.

TABLE 1

| Example 1 | | Example 2 | | Example 3 | |
|---|---|---|---|---|---|
| | meniscus | | meniscus | | meniscus |
| | from | | from | | from |
| wt. % | bottom | wt. % | bottom | wt. % | bottom |
| 2-pentanol | (cm) | 1-pentanol | (cm) | 1-butanol | (cm) |
| 0 | 4.9 | 0 | 4.9 | 0 | 4.9 |
| 2 | 4.7 | 2 | 4.9 | 2 | 4.9 |
| 5 | 4.5 | 5 | 4.8 | 5 | 4.9 |
| 10 | 4.3 | 10 | 4.8 | 10 | 4.8 |
| 15 | 4.3 | 15 | 4.8 | 15 | 4.8 |
| 20 | 4.2 | 20 | 4.7 | 20 | 4.7 |

### Example 4

This example demonstrates the thermodynamic properties of a HFC/2-pentanol blend.

Testing was performed in a refrigeration machine under typical air conditioning conditions using a refrigerant test mixture and mineral oil supplied by the compressor manufacturer (Copeland blended white oil Catalog No. 999-5170-31). The test mixture composition was 91 wt. % of R-407C and 9 wt. % of 2-Pentanol (i.e. 20.93 wt. % R-32, 22.75 wt. % R-125, 47.32 wt. % R-134a, and 9 wt. % 2-Pentanol).

Testing was performed using a setup similar to the unit described in Report DOE/CE/23810-71 “Study of Lubricant Circulation in HVAC Systems,” March 1995-April 1996 by Frank R. Biancardi et. al. (prepared for Air Conditioning and Refrigeration Technology Institute Under ARTI/MCLR Project No. 665-53100), which is incorporated herein by reference. For the present testing, a 2-ton R-22 heat pump was instrumented to measure temperatures, pressures, mass flow, capacity, power consumption, and ultimately efficiency (COP). The system used a hermetic scroll compressor manufactured by Copeland Corporation (model number ZR22K3-PFV).

The performance test conditions were performed using ARI standard B conditions (ARI Standard 210/240, 2003, which is incorporated herein by reference). Table 2 shows performance results compared to R-22. Although capacity and coefficient of performance (COP) are lower for the test mixture as compared to R-22, these values are expected when using similar mixtures (e.g. R-407C) without 2-pentanol due to their inherent thermodynamic properties. In fact, capacity and COP of R-407C tested in the same unit showed similar capacity and even lower COP than the proposed mixture. Therefore, addition of 2-Pentanol does not affect the system performance of an HFC-type fluid.

TABLE 2

| Refrigerant | Capacity (Tons) | COP |
|---|---|---|
| R-22 | 2.18 | 4.04 |
| R-407C | 2.03 | 3.35 |
| Test Mixture | 2.03 | 3.74 |

### Example 5

This example demonstrates that a R-407C/2-pentanol blend has better oil return properties in a refrigeration system as compared to R-407C without 2-pentanol.

These tests utilized the same equipment as described in Example 4, with the following modifications:
1) The suction line was modified to allocate three different size risers (¾″, ⅞″ and 1⅛″) allowing a greater variety of internal velocities. Using all the risers open will impose a very low internal vapor velocity, representing a thorough test for the candidate fluid.
2) An oil level was added to the hermetic compressor, so oil migration from and to the compressor could be tracked.
3) A high-pressure piston pump was used to inject oil extracted from the compressor sump into the compressor discharge line. This gave us the ability to simulate oil pump out conditions as described in Biancardi's report.

These tests consisted in injecting 300 cc of oil, previously extracted from the compressor pump, and observing the oil level. Injecting the same oil amount, two types of tests were performed: 1) With a normal size suction line (risers bypassed) to get usual vapor velocity in the suction line, 2) Using all the risers opened to impose an extreme low vapor velocity in the suction line.

For reference, oil return tests were performed using refrigerant (R-22) and mineral oil, which is a refrigerant/oil combination commonly found in the industry. Oil return was considered satisfactory when the oil level showed a recovery of at least 85% of the oil extracted from the sump. By recovering this amount, the compressor had enough oil to satisfy its lubrication needs and, thus, to extend compressor reliability. During all these tests, both indoor and outdoor conditions were kept at the standard B ARI conditions.

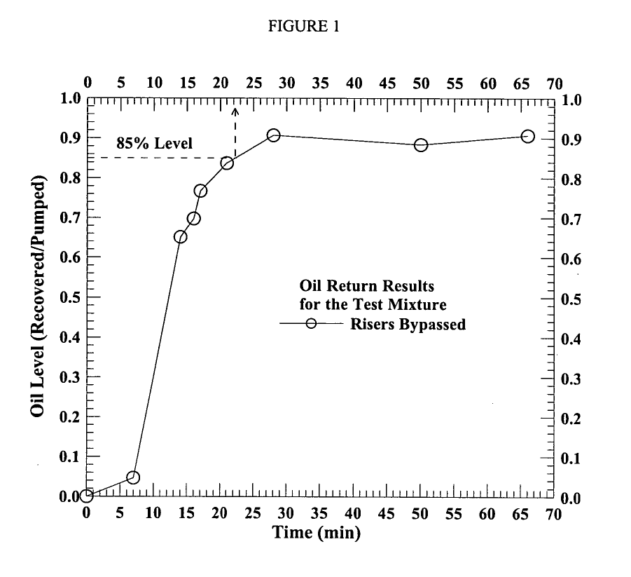

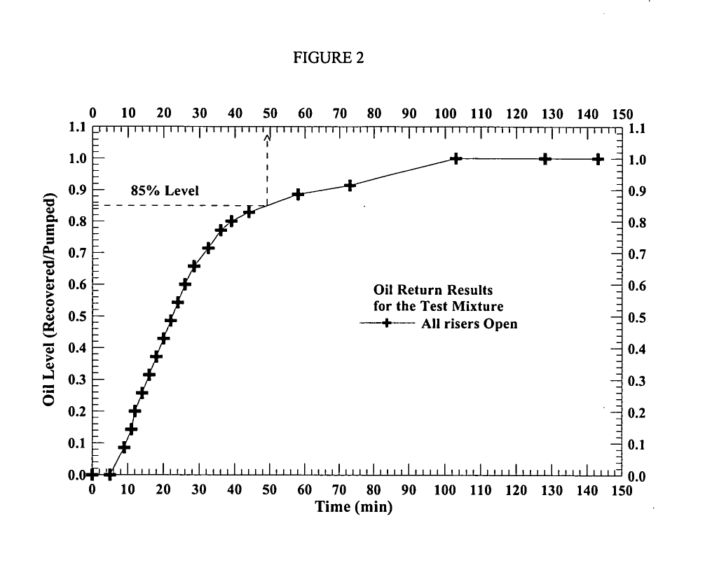

By observing the oil level in the compressor sump versus time (see plots of actual data in FIGS. 1 and 2), it was observed that the oil return time with the test mixture is almost identical to the one obtained with R22, and significantly better than the one obtained with pure R-407C (See Table 3). This example demonstrates that with the test mixture, the oil return in the system is enhanced over R-407C, the leading R-22 alternate refrigerant, without any significant effect on Capacity or COP (as showed in Table 2).

TABLE 3

| | Oil Return Without | Oil Return with |
|---|---|---|
| Refrigerant | Risers (Min) | Risers (Min) |
| R-22 | 24 | 40 |
| R-407C | 87 | N/A |
| Test Mixture (R-407C/2-pentanol) | 22 | 49 |

Having thus described a few particular embodiments of the invention, various alterations, modifications, and improvements will readily occur to those skilled in the art. Such alterations, modifications, and improvements, as are made obvious by this disclosure, are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A composition comprising:
(a) from about 80 weight percent to about 99.9 weight percent of at least one C₁-C₅ hydrofluorocarbon; and
(b) from about 0.1 weight percent to about 20 weight percent of at least one C₃-C₇ alcohol.

2. The composition of claim 1 wherein said C₃-C₇ alcohol is a secondary alcohol.

3. The composition of claim 1 wherein said secondary alcohol is selected from the group consisting of 2-proponal, 2-butanol, 2-pentanol, 2-hexanol, and 2-heptanol.

4. The composition of claim 3 wherein said secondary alcohol is 2-pentanol.

5. The composition of claim 1 wherein said C₁-C₅ hydrofluorocarbon is a refrigerant.

6. The composition of claim 5 wherein said refrigerant is selected from the group consisting of difluoromethane, 1,1,1,2,2-pentafluoroethane, 1,1,1-trifluoroethane, 1,1,1,2-tetrafluoroethane, 1,1-difluoroethane, and blends of at least two of these.

7. The composition of claim 6 wherein said blends are selected from the group consisting of 1,1,1,2,2-pentafluoroethane/1,1,1,2-tetrafluoroethane blends, R-404A, R-507A, R-410A, R-407C, and R-407A.

8. The composition of claim 6 wherein said C₃-C₇ alcohol is a secondary alcohol.

9. The composition of claim 8 wherein said secondary alcohol is 2-pentanol.

10. The composition of claim 9 wherein said refrigerant is 1,1,1-trifluoroethane.

11. The composition of claim 9 wherein said refrigerant is R-404A.

12. The composition of claim 9 wherein said refrigerant is R-507A.

13. The composition of claim 9 wherein said refrigerant is R-410A.

14. The composition of claim 9 wherein said refrigerant is R-407C.

15. The composition of claim 9 wherein said refrigerant is R-407A.

16. The composition of claim 9 wherein said refrigerant is a blend of 1,1,1,2,2-pentafluoroethane and 1,1,1,2-tetrafluoroethane.

17. The composition of claim 1 wherein said composition comprises:
(a) from about 85 weight percent to about 99.9 weight percent of at least one C₁-C₃ hydrofluorocarbon; and
(b) from about 0.1 weight percent to about 15 weight percent of at least one C₃-C₇ alcohol.

18. The composition of claim 1 further comprising a lubricant.

19. The composition of claim 18 wherein said lubricant is selected from the groups consisting of mineral oil, alkyl oil, alkyl benzene oil, paraffinic oil, and mixtures of at least two of these.

20. A method of recharging a refrigeration system comprising the steps of:
(a) providing a refrigeration system from which a chlorine-containing refrigerant has been substantially removed; and
(b) introducing the composition of claim 1 into said refrigeration system.

21. A method of recharging a refrigeration system comprising the steps of:
(a) providing a refrigeration system having at least one chlorine-containing refrigerant and at least one lubricant;
(b) substantially removing said chlorine-containing refrigerants while substantially retaining said lubricant; and
(c) introducing the composition of claim 1 into said refrigeration system.

22. A heat transfer composition comprising:
(a) at least one hydrofluorocarbon; and
(b) at least one C₃-C₇ alcohol.

23. The composition of claim 22 wherein said at least one hydrofluorocarbon is present in an amount of from about 80 weight percent to about 99.9 weight percent of the composition.

24. The composition of claim 22 wherein said at least one hydrofluorocarbons comprises at least one C₁-C₅ hydrofluorocarbon.

25. The composition of claim 22 wherein said C₃-C₇ alcohol is present in an amount of from about 0.1 weight percent to about 20 weight percent of the composition.

26. The composition of claim 22 wherein said C₃-C₇ alcohol is a secondary alcohol.

27. The composition of claim 26 wherein said secondary alcohol is selected from the group consisting of 2-proponal, 2-butanol, 2-pentanol, 2-hexanol, and 2-heptanol.

28. The composition of claim 26 wherein said secondary alcohol is 2-pentanol.

29. The composition of claim 22 wherein said hydrofluorocarbons is selected from the group consisting of difluoromethane, 1,1,1,2,2-pentafluoroethane, 1,1,1-trifluoroethane, 1,1,1,2-tetrafluoroethane, 1,1-difluoroethane, and blends of at least two of these.

30. The composition of claim 29 wherein said blends are selected from the group consisting of 1,1,1,2,2-pentafluoroethane/1,1,1,2-tetrafluoroethane blends, R-404A, R-507A, R-410A, R-407C, and R-407A.

31. The composition of claim 22 wherein said at least one C₁-C₃ hydrofluorocarbon is present in an amount of from about 85 weight percent to about 99.9 weight percent of the composition and said C₃-C₇ alcohol is present in an amount of from about 0.1 weight percent to about 15 weight percent of the composition.

32. The composition of claim 22 further comprising a lubricant.

33. The composition of claim 32 wherein said lubricant is selected from the groups consisting of mineral oil, alkyl oil, alkyl benzene oil, paraffinic oil, and mixtures of at least two of these.

34. The composition of claim 33 wherein said C₃-C₇ alcohol is present in an amount effective to substantially improve the compatibility between said hydrofluorcarbon and said lubricant.

35. A method of replacing an existing heat transfer fluid contained in heat transfer system having an existing lubricant, said method comprising removing at least a substantial portion of said existing heat transfer fluid from said system, said existing heat transfer fluid being selected from the group consisting of HCFC, CFC and combinations of these; and replacing at least a portion of said existing heat transfer fluid by introducing into said system a heat transfer composition comprising at least one hydrofluorocarbon and a least one C₃-C₇ alcohol in an amount effective such that a substantial portion of said lubricant is carried in said system by said at least one hydrofluorocarbon.

36. The method of claim 35 wherein said replacing step is not associated with any substantial modification of said existing heat transfer system.
